(19) United States
(12) Patent Application Publication
(10) Pub. No.: US 2026/0064836 A1
(43) Pub. Date: Mar. 5, 2026

(54) MALWARE DETECTION IN PRETRAINED MACHINE LEARNING MODELS USING BEHAVIOR ANALYSIS

(71) Applicant: Oracle International Corporation, Redwood Shores, CA (US)

(72) Inventors: Ying Dong, Redwood Shores, CA (US); Yongki Choi, Pleasanton, CA (US); Shengming Yu, San Ramon, CA (US); Eileen He, Redwood Shores, CA (US)

(73) Assignee: Oracle International Corporation, Redwood Shores, CA (US)

(21) Appl. No.: 18/823,283

(22) Filed: Sep. 3, 2024

(51) Int. Cl. G06F 21/55; G06F 21/53

(52) U.S. Cl. CPC G06F 21/554; G06F 21/53; G06F 2221/033

(57) ABSTRACT

Techniques for scanning a machine learning (ML) model, which is received over a network, are disclosed. Information associated with the ML model is received. A container image is accessed, based on the information associated with the ML model. A software container is loaded using the container image. The ML model is loaded within the container. A plurality of system calls from the ML model within the container is detected. One or more system calls of the plurality of system calls are categorized as suspicious, e.g., based on the one or more system calls being outside a normal or expected behavior of the ML model. Responsive at least in part on categorizing the one or more system calls of the plurality of system calls to be suspicious, the ML model is tagged as possibly being malicious. A result indicative of the ML model being tagged as possibly being malicious is output.

### BACKGROUND

In the burgeoning field of artificial intelligence (AI), utilization of machine learning (ML) models has become a cornerstone for developing numerous AI applications. However, as ML models become increasingly integral to software development, the susceptibility of ML models to malware attacks has raised significant concerns. The innovative nature of ML makes traditional security measures less effective, posing risks like compromised privacy and loss of server control.

### BRIEF SUMMARY

In some embodiments, a non-transitory computer-readable medium includes instructions that when executed by one or more processors, cause a system including the one or more processors to perform operations including receiving a machine learning (ML) model over a network; accessing a container image based at least in part on information associated with the ML model; loading a software container using the container image; loading the ML model within the container; detecting a plurality of system calls from the ML model within the container; categorizing one or more system calls of the plurality of system calls to be suspicious; responsive at least in part on categorizing the one or more system calls of the plurality of system calls to be suspicious, tagging the ML model as possibly being malicious; and outputting a result indicative of the ML model being tagged as possibly being malicious. In an example, receiving information associated with the ML model comprises receiving an identification of a software framework of the ML model; and accessing the container image comprises one of (i) selecting the container image from among a plurality of container images or (ii) building the container image, such that the selected or built container image supports the software framework of the ML model.

In an example, the operations further include defining a test for the ML model; and executing the test on the ML model, wherein the test on the ML model includes loading the ML model within the container; wherein detecting the plurality of system calls from the ML model comprises detecting the plurality of system calls from the ML model, while the test is being executed on the ML model. In an example, the test on the ML model further includes the ML model to output an inference, based on an input. In an example, the test on the ML model comprises one of issuing a load command to load the ML model, and an inference command to output the inference; or issuing a pipeline command to load the ML model and to output the inference. In an example, defining the test for the ML model comprises selecting the test from among a plurality of tests for the ML model, or receiving the test via a user interface.

In an example, the operations further include receiving the information associated with the ML model, wherein the information comprises one or more of (i) a software framework of the ML model, (ii) a path to a storage repository that stores the model, and (iii) a checksum of one or more files including the ML model. In an example, categorizing one or more system calls of the plurality of system calls to be suspicious comprises detecting (i) a first system call to access a first file including sensitive information, and (ii) a second system call to access a second file including non-sensitive information; and categorizing the first system call to be suspicious, without categorizing the second system call to be suspicious. In an example, the sensitive information comprises one or more of (i) a plurality of passwords, (ii) one or more private keys, and (iii) operating system level information stored in the first file that is a system file; and the non-sensitive information comprises data that is to be accessed by a legitimate ML model during its course of operation. In an example, categorizing the one or more system calls of the plurality of system calls to be suspicious comprises detecting the one or more system calls to at least one of (i) bind to a network port, (ii) establish a non-Transport Layer Security (non-TLS) connection with an Internet Protocol (IP) address, (iii) attempt to establish a connection with an IP address that is excluded from a list of predefined IP addresses, and (iiiv) requests access for more than a threshold number of times to computing resources outside a current directory of the ML model; and categorizing the one or more system calls of the plurality of system calls to be suspicious, responsive at least in part on detecting the one or more system calls to at least one of (i) bind to the network port, (ii) establish the non-TLS connection, (iii) attempt to establish a connection with an IP address that is excluded from a list of predefined IP addresses, and (iv) requests access for more than the threshold number of times.

In an example, categorizing the one or more system calls of the plurality of system calls to be suspicious comprises determining that (i) a first system call of the plurality of system calls is within an expected behavior of the ML model, and (ii) a second system call of the plurality of system calls is outside the expected behavior of the ML model; and categorizing the second system call to be suspicious, without categorizing the first system call to be suspicious. In an example, the operations further include prior to loading the ML model within the container, configuring a network mode of the container to disable, thereby one or both of (i) disabling inbound traffic to the container, and (ii) disabling outbound traffic from the container. In an example, the operations further include prior to loading the ML model within the container, configuring the container to use a subset of a plurality of resources accessible to the container. In an example, the ML model is a pre-trained ML model. In an example, the operations further include receiving the ML over the network from a model repository storing a plurality of pre-trained ML models.

In an example, categorizing the one or more system calls of the plurality of system calls to be suspicious comprises categorizing a first system call of the plurality of system calls to have a first level of suspicion; and categorizing a second system call of the plurality of system calls to have a second level of suspicion that is different from the first level of suspicion. In an example, the operations further include assigning a score to the ML model, the score indicative of a degree of suspicion associated with the ML model being malicious. In an example, the score is based at least in part on (i) a first number of system calls having the first level of suspicion, and (ii) a second number of system calls having the second level of suspicion. In an example, tagging the ML model as possibly being malicious comprises tagging the ML model as possibly being malicious, responsive at least in part on the score being higher than a threshold value. In an example, detecting the plurality of system calls comprises detecting the plurality of system calls using a trace utility.

In some embodiments, a computer implemented method includes receiving a machine learning (ML) model over a network; accessing a container image based at least in part of information associated with the ML model; loading a software container using the container image; loading the ML model within the container; detecting a plurality of system calls from the ML model within the container; categorizing one or more system calls of the plurality of system calls to be suspicious; responsive at least in part to categorizing the one or more system calls of the plurality of system calls to be suspicious, tagging the ML model as possibly being malicious; and outputting a result indicative of the ML model being tagged as possibly being malicious. In an example, receiving information associated with the ML model comprises receiving an identification of a software framework of the ML model; and accessing the container image comprises selecting the container image from among a plurality of container images, such that the selected or built container image supports the software framework of the ML model. In an example, categorizing the one or more system calls of the plurality of system calls to be suspicious comprises determining that (i) a first system call of the plurality of system calls is within an expected behavior of the ML model, and (ii) a second system call of the plurality of system calls is outside the expected behavior of the ML model; and categorizing the second system call to be suspicious, without categorizing the first system call to be suspicious.

In an example, a system includes one or more processors; a storage repository configured to store a machine learning (ML) model that is received over a network; and one or more non-transitory computer-readable media storing instructions, which, when executed by the system, cause the system to perform a set of actions including receiving information associated with the ML model; accessing a container image, based at least in part of the information associated with the ML model; loading a software container using the container image; loading, from the storage repository, the ML model within the container; detecting a plurality of system calls from the ML model within the container; categorizing one or more system calls of the plurality of system calls to be suspicious; responsive at least in part to categorizing the one or more system calls of the plurality of system calls to be suspicious, tagging the ML model as possibly being malicious; and outputting a result indicative of the ML model being tagged as possibly being malicious. In an example, the ML model is a pretrained ML model received over the Internet from a cloud-based open-source repository.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a system for dynamic testing of a pre-trained ML model within an encapsulated software container environment.

FIG. 2 illustrates a user interface (UI) for providing information about an ML model to be scanned.

FIG. 3 illustrates an example scan list summarizing a plurality of scan results based on scanning a plurality of ML models.

FIG. 4 illustrates a report including suspicious behaviors detected, based on a scan of a ML model.

FIG. 5 illustrates a method depicting a scanning process of a pretrained ML Model, to detect possibly suspicious and malicious behavior of the ML model.

FIG. 6 depicts a simplified diagram of a distributed system for implementing certain aspects.

FIG. 7 is a simplified block diagram of one or more components of a system environment by which services provided by one or more components of an embodiment system may be offered as cloud services, in accordance with certain aspects.

FIG. 8 illustrates an example computer system that may be used to implement certain aspects.

### DETAILED DESCRIPTION

Machine learning (ML) models have become increasingly popular in the last few years. Pre-trained ML models are used for developing machine learning applications. For example, open-source cloud-based repositories offer pre-trained ML models for download, and a developer can download and start using a pre-trained ML, without having to develop the model from scratch or to train the model. These ML models are often pretrained on vast datasets, and offer a significant head-start to developers, allowing for the creation of sophisticated AI systems without the need for starting from scratch and training the model. Thus, availability of pre-trained ML models accelerates the AI development process.

However, this reliance on pre-trained models introduces new vulnerabilities. Similar to how attackers might embed malicious code within open-source software, pre-trained models (e.g., such as those that are available from open-source cloud-based repositories) may be susceptible to being tampered with. The inclusion of malicious code within these pre-trained ML models poses a substantial threat, given that machine learning models often have access to sensitive or critical data.

The risk in using such pre-trained ML models may be exacerbated by the rapid evolution of machine learning technologies. As these technologies advance, the tools available for static scanning and detecting malicious code in pre-trained ML models struggle to keep pace. For example, a static scanning tool may examine the codes of a pre-trained ML model, to detect signature of malicious codes. However, malicious code embedded within machine learning models may be difficult to detect, making it challenging for static detection tools that rely on review of code patterns, to identify new and emerging threats. For example, instead of static analysis of the codes of a ML model, the techniques described herein rely on dynamic scanning of behavior of the ML model, while the ML model is being loaded and possibly executed within a secure container environment.

For example, once an ML model is downloaded from a source (such as an online model repository), the ML model is loaded and executed, and its behavior is scanned and observed. However, as the ML model can possibly be malicious, to safeguard the scanning process itself, the ML model is loaded and executed within a software container environment, such as a sandbox environment. A software container is a standardized unit of software that allows for isolation of applications being executed within the container from the environment and operating system (OS) within which the container executes. Thus, the container provides an encapsulated environment (such as a sandbox environment) in which applications or functions, such as the ML model, may be loaded and/or executed. The container environment isolates the ML model, its operational framework, and the scanning tool from the rest of the system. Such isolation ensures that any malicious code within the ML model cannot compromise the model scanner system or the broader system infrastructure.

Within this container, a series of predefined test cases can be performed on a pre-trained ML model. These test cases are designed to mimic typical operational behavior of the ML model, such as loading the ML model and performing inference tasks. Such test cases may facilitate in provoking any malicious behavior of the ML model that would be observable during the runtime of the ML Model.

In an example, a container is defined by a software image and one or more configuration files, and includes libraries and dependencies for loading and/or executing the ML model within the container. In an example, a configuration and a type of the container may depend on a type of the ML model to be scanned. For example, the runtime environment of the container is tailored with libraries that can support the ML model. For example, information about the ML Model to be scanned (such as a software framework of the ML model, a version of the ML model, etc.) are accessed, which facilitates in selecting a correct configuration of the container, as described below in further detail.

The model scanner described herein is designed with pre-configured environments for common machine learning frameworks. For example, as and when the framework of the ML model changes, a corresponding container is selected that can support the framework of the ML model. The underlying monitoring tools remain the same, as system calls (which are representative of the behavior of the ML model, described below) made by the ML models from the containers are independent of the software frameworks of the ML models. For example, the model scanner is agnostic to the higher-level frameworks or programming languages used for the ML models. This universality means that these techniques are equally effective across different machine learning frameworks and adaptable to future ones, ensuring broad and enduring applicability.

While the ML model is being loaded and/or executed within container, system calls issued by the ML model from within the container are traced. Merely as an example, if the model scanner has a Linux® OS, then a trace utility may be used to trace the system calls, where the trace utility is a diagnostic userspace utility for Linux®. Thus, a monitoring service monitors interactions between the container (which is loading and/or executing the ML model) and the underlying OS of the model scanner, and each such interaction is a system call made by the ML model within the container.

These system calls, including actions such as open at, read, write, bind, and connect, and/or the like, provide insights into how the model interacts with essential system resources, such as network connections, file system, and input/output (I/O) resources.

During the scanning process of the system calls, the system calls may be compared to a “safe list” comprising safe system calls and/or a “suspicious list” of possibly suspicious system calls. The safe list comprises behaviors and objects that are deemed normal or expected for a ML model, such as accessing files within a current directory of the ML model, connecting to safe network addresses, and/or the like. Given the relatively straightforward nature of operation of ML models (e.g., which contrasts with the complexity of general-purpose software applications), it is feasible to delineate such expected behaviors. Following the loading and/or execution of the ML model, the monitoring service detects and analyses the tracked system calls, filtering out those that match behaviors outlined in the safe list. The residual system calls, which deviate from the norm or expected behavior, may match with the suspicious list of system calls. These system calls are flagged as being suspicious. Through such dynamic scanning approach, possibly suspicious behavior of a possibly malicious ML model can be identified.

Merely as an example, a system call from the ML model within the container to access, such as read, modify, and/or delete sensitive files may be categorized as being suspicious, where examples of such sensitive files include files storing passwords, private keys, and/or system level files. In another example, system calls attempting to communicate over a network (such as send a message over the network), listen on a network port, establish a non-Transport Layer Security (non-TLS) connection with an unrecognized website or an unrecognized IP address, establish a connection with an IP address that is outside a list of verified or predefined or safe IP addresses, or bind to a network port may be deemed suspicious. In yet another example, system calls attempting to access resources outside the current directory may be deemed suspicious. Various examples of possibly malicious system calls have been described below in further detail.

Thus, the techniques described herein are based on a dynamic scanning of the ML model, e.g., scanning the ML model behavior while the ML model is being loaded and/or executed. Thus, the techniques described herein are a departure from static analysis of a ML model, where codes within the ML model are examined to detect anomalies and issues within the code (e.g., without executing the codes). While effective for identifying certain vulnerabilities, static scanning often lacks the capability to detect issues that only manifest during runtime.

Note that a runtime behavior of an ML model is essentially different from a runtime behavior of general software applications. For example, usual software applications, during their regular course of operation, are expected to connect to a network, transmit messages over the network, bind to network ports, or access sensitive files described above. However, ML models reside at the backend, and usually receive inputs and provide inference results, and do not perform the above-described tasks generally performed by general software applications. Thus, due to the relatively straightforward nature of operation of ML models (e.g., which contrasts with the complexity of general-purpose software applications), it is feasible to differentiate between suspicious and safe behaviors of ML models. Accordingly, it is possible to scan the system calls made by various types of ML models having various types of frameworks and used for various types of applications, and categorize individual system calls to be either safe or possibly malicious, e.g., due to the uniformity of runtime behavior of ML models in general. This in turn helps in identifying possibly malicious ML models, as described below in further detail.

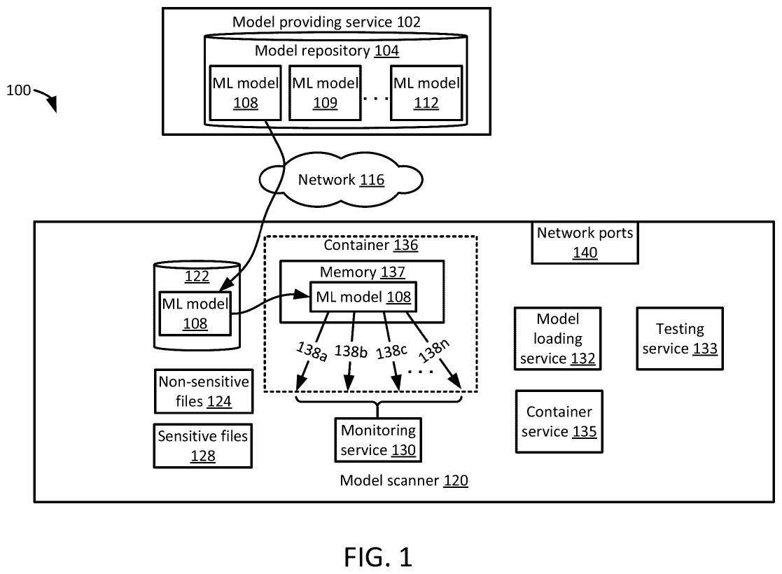

FIG. 1 illustrates a system 100 for dynamic testing of a pre-trained ML model 108 within an encapsulated software container environment. The system 100 includes a model providing service 102 including a storage repository 104. While shown as a single storage repository in FIG. 1, the storage repository 104 can include multiple storage repositories. The storage repository 104 includes, among other things, a plurality of ML models 108, 109, . . . , 112. The model providing service 102, including the storage repository 104, may provide such ML models 108, . . . , 112 for download. The ML models 108, . . . , 112 may be any ML models and may be used for any artificial intelligence applications.

In an example, one or more of the models 108, . . . , 112 (such as all the models 108, . . . , 112) may be pretrained ML models. For example, the model providing service 102 provides pretrained ML models for download from the storage repository 104. The models 108, . . . , 112 may be pretrained using any training data and using any training techniques.

In an example, thus, the model providing service 102 may be an open-source cloud-based ML model repository, from where users can download pretrained ML models and use the downloaded models, without having to develop the ML models and/or train the ML models.

The model providing service 102 is, in an example, a cloud-based service providing its services over a network 116. Thus, individual users (such as devices of users) may download one or more of the ML models 108, . . . , 112 over the network 116. The network 116 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network 116 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth™, and/or any other wireless protocol), and/or any combination of these and/or other networks. In one example, the network 116 includes the Internet, and the pre-trained ML models 108, . . . , 112 are downloadable from the cloud-based online model storage repository 104 provided by the model providing service 102.

In an example, a user can download any one or more of the ML models 108, . . . , 112 from the storage repository 104. Downloading and testing of an example ML model 108 is described below, although any of the ML models 108, . . . , 112 may be downloaded.

In an example, a developer develops and trains a ML model (such as the ML model 108), and uploads the ML model to the model repository 104. Thus, the model providing service 102 provides an open-source online cloud-based repository to share pretrained ML models among various developers and users. However, the model providing service 102 may not check the uploaded ML model for malicious codes. For example, one or more of the open-source ML models 108, . . . , 112 may be malicious, because (i) these ML models may not have undergone through rigorous testing by the model providing service 102 and/or (ii) developers uploading the ML models 108, . . . , 112 may not be fully trusted developers. For example, similar to the manner in which attackers might embed malicious code within open-source software, pretrained ML models within the model repository 104 may also be susceptible to being tampered with. The inclusion of malicious code within these ML models poses a substantial threat, given that machine learning models often have access to sensitive or critical data when being used.

Accordingly, in an example, any ML model downloaded from the model repository 104 is scanned and tested for possible malicious behavior, prior to the ML model being put in use. As described below in detail, testing a ML model 108 involves loading and/or executing the ML model 108 in an encapsulated container environment, and scanning the ML model 108 for suspicious behavior(s). Phrases like scanning and testing are used interchangeably in this disclosure.

For example, FIG. 1 illustrates a model scanner 120 configured to download the ML model 108 from the model repository 104, and scan the ML model 108 for possible malicious behavior. The model scanner 120 may be implemented by an end user device, by a cloud-based server, or the like.

The model scanner 120 comprises (or has access to) a storage repository 122. The model scanner 120 downloads the ML model 108 over the network 116, and stores the ML model 108 within the storage repository 122.

In an example, the model scanner 120 (such as a container service 135 within the model scanner) initiates a software container 136 (henceforth referred to as container 136) within which the ML model 108 is loaded and/or executed. The container 136 is a standardized unit of software that allows for isolation of applications being executed within the container 136 from the environment and operating system within which the container 136 executes. Thus, the container 136 provides an encapsulated environment (such as a sandbox environment) in which applications or functions, such as the ML model 108, may be loaded and/or executed.

In an example, the container 136 is defined by a software image and one or more configuration files, and includes libraries and dependencies for loading and/or executing the ML model 108 within the container 136. For example, a container image becomes the container 136 at runtime, e.g., when the container image is executed on a corresponding container engine.

The container 136 may operate on any operating system (OS), such as Windows® OS, Linux®, Mac®, or the like. Any type of container may be used, such as a Docker Container® provided by Docker® merely as an example.

In an example, a memory 137 is provisioned within the container 136, and the ML model 108 is loaded within the memory 137 from the storage repository 122. In an example, the container 136 may also execute the ML model 108. Loading and/or executing the ML model 108 within the environment of the container 136 prevents or reduces possibility of a malicious ML model harming or corrupting the model scanner 120. Because the ML model 108 is being loaded and/or executed within the encapsulated and sandboxed container environment, even if the ML model 108 is possibly malicious, the encapsulated container environment reduces possibility of the possibly malicious ML model 108 from causing any harm outside the container 136.

In an example, a configuration and the type of the container 136 may depend on a type of the ML model 108. For example, a runtime environment of the container 136 may be selected based on a type of the ML model 108. In an example, the runtime environment is tailored with libraries that can support the ML model 108. For example, if the ML model 108 is a version of PyTorch® (such as PyTorch 1.3), an image of the container 136 for the PyTorch 1.3 ML model 108 may include commonly used libraries for PyTorch ML models, such as Numpy® and HuggingFace® Transformers.

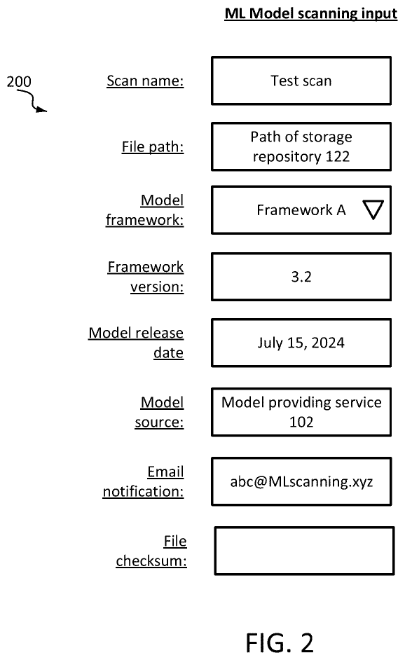

In an example, after a ML model 108 is downloaded to the storage repository 122 and prior to the container 136 is launched, a user of the model scanner 120 (e.g., who wants the ML model 108 to be tested) inputs information about the ML model 108 to be scanned or tested to a testing service 133 provided by the model scanner 120, e.g., using an user interface, as described below with respect to FIG. 2. The testing service 133, for example, receives information such as a name or identification of the ML model 108, and a path of a storage repository where the ML model 108 is stored. For example, the storage repository where the ML model 108 is stored can be any of (i) the local storage repository 122 or (ii) a cloud-based storage repository, such as the model repository 104.

The testing service 133, for example, receives further information such as a framework of the ML model 108, programming language required to load and/or execute the ML model 108, a version number of the ML model 108, and/or the like.

Such information associated with the ML model 108 facilitates in choosing a correct configuration of the container 136, and/or tailor the scanning process to the specific requirements of the ML model 108. For example, as described above, if the ML model 108 is a version of PyTorch® (such as PyTorch 1.3), an image of the container 136 for the PyTorch 1.3 ML model 108 may include commonly used libraries for PyTorch ML models, such as Numpy® and HuggingFace® Transformers.

FIG. 2 illustrates a user interface (UI) 200 for providing information about the ML model 108 to be scanned. The end user provides such information via one or more user interface input devices, such as a keyboard, a pointing device such as a mouse or trackball, a touchpad or touch screen incorporated into a display, a scroll wheel, a click wheel, a dial, a button, a switch, a keypad, audio input devices with voice command recognition systems, microphones, and other types of input devices. The information about the ML model 108 to be scanned is received by the testing service 133. Example fields within the UI 200 include a scan name (an example value of which is “Test scan” in FIG. 2), and a file path in which the ML model 108 is currently stored. An example file path illustrated in FIG. 2 is a path of the storage repository 122 of FIG. 1. In another example, the file path may be a path of the cloud-based model repository 104.

Further example fields within the UI 200 include a ML model framework, such as a software framework used to develop the ML model 108. A framework may be selected from a dropdown list, where all frameworks supported by the model scanner 120 are included within the dropdown list. Examples of such model software framework include, but are not limited to, PyTorch®, TensorFlow®, Keras®, Apache MXNet®, Amazon® SageMaker®, Apache SINGA®, and/or the like.

In an example, the UI 200 may also include an option to input a version number of the framework, and a release date of the ML model 108. In an example, the UI 200 may also include an option to provide a source from which the ML model was downloaded, which may be an identification of the model providing service 102. In an example, the UI 200 may also include an option to provide an email address in which result and reports of the scanning of the model can be emailed. In an example, the UI 200 may also include an option to provide a file checksum of the ML model 108, e.g., to ensure that the ML model 108 is correctly copied to the container 136.

Referring again to FIG. 1, in an example, based on the information associated with the ML model 108 received by the testing service 133 (such as via the UI 200), a container service 135 (e.g., which is provided by the model scanner 120) builds an image for the container 136 (or selects an image for the container 136 from a pre-built library of container images). For example, as described above, if the ML model 108 comprises a version of PyTorch® (such as PyTorch 1.3), an image of the container 136 for the PyTorch 1.3 ML model may include commonly used libraries for PyTorch ML models, such as Numpy® and HuggingFace® Transformers. The container service 135 then loads the container 136 from the built or selected container image.

Once the container service 135 loads the container 136, the container 136 includes a memory 137 provisioned for the container 136. The container 136 then loads the ML model 108 within the memory 137.

In an example, to safeguard against risks associated with the ML model 108 being malicious, the ML model 108 may be mounted or loaded (or at least initially mounted) to the container 136 in a read-only mode. This approach controls I/O risks, such as one or more I/O ports and/or devices of the model scanner 120 being attacked by a possibly malicious ML model 108. In an example, the container 136 may be configured such that a network mode of the container 136 is set to a none, or null, or disabled, such that inbound network traffic to the container 136 and/or outbound network traffic form the container 136 is at least initially disabled or disallowed. Such precautions may prevent or at least reduce chances of network-based attacks by the possibly malicious ML model 108. In another example, the container 136 may be configured to use a subset of a plurality of resources accessible to the container. Merely as an example, assume that the model scanner 120 has 8 processing cores, 64 GB memory, and three hard disk drives, each of which may be made accessible to the container 136. However, the container 136 may be configured to use only a subset of such processing cores, memory, and/or the hard disk drive (such as at most 4 processing cores, 32 GB memory, and/or one specific hard disk drive). In an example, such precautions may prevent or at least reduce chances of consumption of large amount of computing resources by the container 136.

In an example, once the ML model 108 is saved within the container 136, is the ML model 108 may be tested for security vulnerabilities. For example, the test of the ML model 108 includes loading the ML model 108 and/or executing the ML model to output inferences. The test of the ML model 108 may be configured in an example, such as by a user. In another example, the test to be conducted on the ML model 108 may be selected from a plurality of predefined or preconfigured tests. Each test may load and/or execute the model in a different manner. For example, a first test may include (i) a load command to load the ML model 108, and (ii) an execute or inference command to cause the ML model 108 to draw inferences (such as by executing the ML model 108). In an example, a second test may include a pipeline command that combines the loading and inferencing tasks. In yet an example, a third test may include loading the ML model 108, without performing the inferencing tasks. In an example, a test may be selected or defined from a plurality of candidate tests, and the ML model 108 may be made to undergo the selected or defined test. The testing of the ML model 108 is performed within the container 136, as described above.

While and/or subsequent to the ML model 108 is tested (e.g., loaded to the container 136 and/or executed), a monitoring service 130 monitors (such as detects, analyzes, and categorizes) one or more system calls 138a, . . . , 138n made by the ML model 108 from the container 136. While FIG. 1 illustrates the monitoring service 130 being external to the container 136, in an example, the monitoring service 130 may also be internal to the container 136. Thus, the monitoring service 130 may be executed by the model scanner 120 and/or by the container 136. In an example, the monitoring service 130 may be a part of the testing service 133. In an example, the ML model 108 is executed within the container, and system calls 138a, . . . , 138n made by the ML model 108 are monitored (such as detected, analyzed, and categorized) by the monitoring service 130.

FIG. 1 illustrates a plurality of system calls 138a, . . . , 138n made by the ML model 108, e.g., while or subsequent to the ML model 108 is loaded, and/or while the ML model 108 is being executed (such as making inferences, based on corresponding inputs). The system calls 138a, . . . , 138n are made by the ML model 108 within the container to an OS of the model scanner 120. As described above, the monitoring service 130 scans or traces the system calls 138a, . . . , 138n made by the ML model 108. Merely as an example, if the container 136 has a Linux® OS, then the monitoring service 130 uses trace utility to trace the system calls 138a, . . . , 138n, where the trace utility is a diagnostic userspace utility for Linux®. Thus, the monitoring service 130 detects interactions between the container 136 (which is loading and/or executing the ML model 108) and the OS (such as a Linux kernel) of the model scanner 120, and each such interaction is a system call 138 made by the container 136. Thus, each of the system calls 138a, . . . , 138n may be representative of an intended interaction between the container 136 and the OS system supporting the container 136.

In an example, the system calls 138a, . . . , 138n may be for a variety of purposes. Some of the system calls 138a, . . . , 138n may be benign, and may be for legitimate operation of a benign ML model 108. In an example, if the ML model 108 is malicious, one or more of the system calls 138a, . . . , 138n may be malicious, which may be detected by the monitoring service 130.

During the scanning process of the system calls 138a, . . . , 138n, the system calls 138a, . . . , 138n are compared to a “safe list” comprising safe system calls and/or a “suspicious list” of possibly suspicious system calls. The safe list comprises behaviors and objects that are deemed normal or expected for a ML model, such as accessing files within a current directory of the ML model 108, connecting to safe network addresses, and/or the like. Given the relatively straightforward nature of operation of ML models (e.g., which contrasts with the complexity of general-purpose software applications), it is feasible to delineate such expected behaviors. Following the testing (such as loading and/or execution) of the ML model 108, the monitoring service 130 analyses the tracked system calls, filtering out those that match behaviors outlined in the safe list. The residual system calls, which deviate from the norm or expected behavior, may match with the suspicious list of system calls. These system calls are flagged as being suspicious. Through such dynamic scanning approach, possibly suspicious behavior of a possibly malicious ML model can be identified, as described below in further detail.

In an example, the model scanner 120 may include, or have access to, one or more non-sensitive files 124 and one or more sensitive files 128. In an example, the sensitive files 128 may include relatively sensitive information, such as passwords, private keys, credit card information, and/or other sensitive information. In another example, the sensitive files 128 may include system level files that the ML model 108 may not have legitimate purpose to access.

In an example, the non-sensitive files 124 may include relatively non-sensitive information, such as data. Note that the sensitivity of information may be from a perspective of the OS of the model scanner and/or from the perspective of the container 136. For example, a sensitive file 128a may be stored in a location in which the OS stores files including passwords, and another sensitive file 128b may be stored in a location in which the OS stores files including private keys. In contrast, a non-sensitive file 124 may be stored in a location in which the OS doesn't store files including passwords and/or private keys.

In an example, the monitoring service 130 detects and analyzes the system calls 138a, . . . , 138n, to determine whether the ML model 108 is trying to access, write, and/or delete one or more of the sensitive files 128. For example, a system call 138 for accessing (such as reading from, writing to, or deleting) a non-sensitive file 124 may not be deemed suspicious by the monitoring service 130, as the ML model 108 may have legitimate reasons to access such a non-sensitive file 124 (e.g., may have legitimate reasons to access data within a non-sensitive file 124).

However, generally, a ML model 108 may not have any legitimate reason to access (such as read, modify, write, or delete) a sensitive file 128. Thus, another system call 138 to access a sensitive file 128 by the container 136 (such as by the ML model 108 within the container 136) may be deemed as suspicious, as the ML model 108 may not have any legitimate reason to access sensitive information within the sensitive files 128.

Note that a ML model (such as the ML model 108) is different from a general software application, in the sense that a general software may have legitimate reasons to access sensitive files. For example, a software application may have legitimate reasons to access passwords, private keys, and/or other sensitive information, for regular operation of the software application. Accordingly, if a general software application is being scanned within the container 136, a system call to a sensitive file 12 may not necessarily be deemed suspicious, as a legitimate general software applications may, during its usual course of operation, access such sensitive information. In contrast, ML models receive inputs from frontend web services and provide inferences as output, and may not have legitimate reasons to access any such sensitive information. Accordingly, a system call 138 to access such sensitive information within a sensitive file 128 may be deemed suspicious (e.g., suspicious of the ML model being possibly malicious). Accordingly, in such a scenario, the monitoring service 130 tags the ML model 108 as being suspicious, based on such behavior of the ML model 108.

In an example, the ML model 108 is configured to act as a backend model, while a frontend service (such as a frontend web service) provides inputs to the ML model 108, and the ML model 108 provides inferences. Thus, although the front-end service associated with the ML model 108 may have legitimate reasons to communicate over a network, the ML model 108 itself may not have legitimate reasons to communicate over a network (such as send a message over the network), listen on a network port, or bind to a network port. For example, the model scanner 120 has one or more network ports 140. An attempt to communicate over one or more of the network ports 140, listen on one or more of the network ports 140, and/or bind to one or more of the network ports 140 may be deemed suspicious. For example, if the monitoring service 130 detects a system call 138 that is associated with an unusual network associated behavior, the monitoring service 130 tags such a behavior of the ML model 108 as being suspicious. Examples of such unusual network associated behavior may include attempts to communicate over one or more of the network ports 140, listen on one or more of the network ports 140, bind to one or more of the network ports 140, attempt to establish a connection with an IP address that is outside a list of verified or predefined or safe IP addresses, and/or attempt to establish a non-Transport Layer Security (non-TLS) connection with an unrecognized website or an unrecognized IP address. For example, a malicious ML model may exhibit such behavior, e.g., so that the malicious ML model may maliciously exfiltrate data from a device in which the ML model is operating to outside device.

In an example, if the monitoring service 130 detects suspicious or abnormal I/O requests, the monitoring service 130 tags the behavior as being suspicious. Examples of such suspicious or abnormal I/O requests include one or more system calls by the ML model 108 outside one or more current directories (i) in which the ML model 108 is operating from and/or (ii) in which the ML model 108 is to store inference results to and/or access data from. For example, if more than a threshold number of access requests are detected to access resources outside the one or more current directories, the monitoring service 130 tags the behavior as being suspicious.

Note that a ML model (such as the ML model 108) is also different from a general software application, in the sense that a general software application may have legitimate reasons to communicate over a network, bind to a network port, and/or access files outside of its current directory. For example, a webservice (which acts as a front-end of the ML model) is such an example of a general software application, and the webservice is supposed to listen to a network port, e.g., to detect incoming requests for the backend ML model. Accordingly, if a general software application is being scanned within the container, a system call to perform any of these actions may not necessarily be deemed suspicious. In contrast, ML models generally have no reason to perform such actions (as the ML model is supposed to receive inputs from the front-end webservice through an API and provide inference results back to the front-end webservice through an API). Hence, in an example, any such action detected by the monitoring service 130 may result in the ML model 108 being tagged as suspicious.

In an example, in addition to detecting suspicious behavior of a ML model (such as the ML model 108), the monitoring service 130 may also score each suspicious behavior, e.g., based on a severity of the suspicious behavior. For example, assume that a ML model issues a system call to read a sensitive file 128 that is a system level file and/or that stores password, but the ML model makes no attempt to communicate over a network or bind with a network port. In such a scenario and merely as an example, the suspicious behavior of reading the sensitive file 128 may be ranked as a “low” level of suspicious behavior. This is because even if sensitive information of the sensitive file 128 is being read by the ML model, the ML model does not make any attempt to exfiltrate the sensitive information to outside the container 136.

In another example, assume that a ML model issues a system call to read a sensitive file 128 that is a system level file and/or that stores password, and the ML model also issues another system call to communicate over a network or bind with a network port. In such a scenario, the suspicious behavior of reading the sensitive file 128 may be ranked as a “high” level of suspicious behavior. This is because not only the sensitive information of the sensitive file 128 is being read by the ML model, but the ML model is also possibly attempting to exfiltrate the sensitive information to outside the container 136 and over a network.

In yet another example, assume that (i) a first ML model makes a system call to read a sensitive file 128 and (ii) a second ML model makes a system call to modify or delete a sensitive file 128. Also assume that none of these first and second models attempt to communicate over a network or bind with a network port. In such a scenario, the suspicious behavior of the first ML model may be ranked as a “low” level of suspicious behavior, and the suspicious behavior of the second ML model may be ranked as an “intermediate” or a “high” level of suspicious behavior.

Although low, intermediate, and high are used as example levels of suspicious behavior, there may be other types of levels or scores of suspicious behavior, such as scores between 1 and 10, or just low and high level.

In an example, the system calls 138a, . . . , 138n are recorded by the monitoring service 130. As described above, if the monitoring service 130 deems one or more of the system calls 138a, . . . , 138n as being suspicious, the monitoring service 130 tags the ML model 108 as possibly being malicious. In an example, the monitoring service 130 may itself comprise a pre-trained ML model that is trained to detect suspicious system calls from within the container 136. In another example, the monitoring service 130 comprises a software service that monitors the system calls, to determine suspicious system calls, if any, from the container 136.

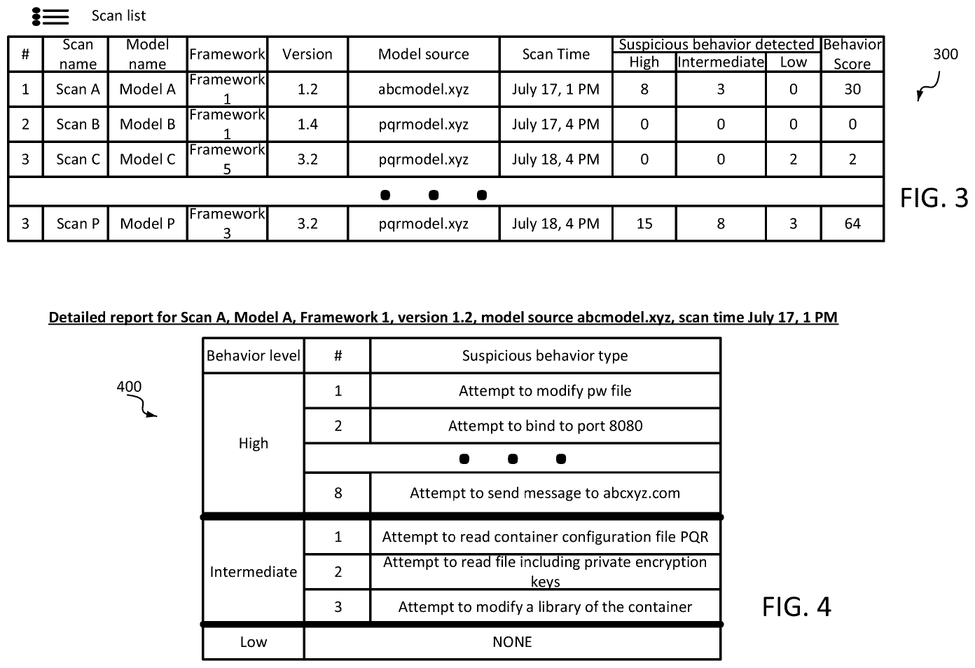

FIG. 3 illustrates an example scan list 300 summarizing a plurality of scan results based on scanning a plurality of ML models. In an example, the scan list 300 may be generated by the monitoring service 130, based on monitoring suspicious behavior while scanning a plurality of ML models.

The scan list 300 includes columns for scan name, model name, software framework of individual ML models, version numbers of individual ML models, and model source, each of which have been described above with respect to FIG. 2, and each of which are self-explanatory in view of FIGS. 2 and 3. The scan list 300 includes a column for a scan time (e.g., a time at which the scanning was performed).

The scan list 300 also includes a plurality of columns for a plurality of detected levels of suspicious behavior. In the example of FIG. 3, three example levels of high, intermediate, and low are used. For example, for scan A of a ML model A, 8 high level and 3 intermediate level of suspicious behaviors were detected; for scan B of a ML model B, no suspicious behavior was detected; and so on.

In an example, each scan is also given a corresponding behavior score. The higher the behavior score, the more suspicious the ML model is and the higher is the probability of the ML model being malicious. A corresponding weightage may be given to the various levels of behavior, to calculate the score. Merely as an example, to arrive at the behavior score, the high suspicious behavior is given a weightage of 3, the intermediate suspicious behavior is given a weightage of 2, and the low suspicious behavior is given a weightage of 1. This results in the ML model A having a behavior score of 30, the ML model B having a behavior score of 0, the ML model C having a behavior score of 2, the ML model P having a behavior score of 64, and so on, as illustrated in FIG. 3.

In an example, the behavior score may be used to determine if a ML model is possibly malicious. A threshold score may be used for such determination. Merely as an example, a threshold score of 5 or higher may be used to tag a corresponding ML model to be possibly malicious. In another example, the threshold score may be zero or higher. Any other type of criteria may also be used for tagging a ML model to be possibly malicious.

FIG. 4 illustrates a report 400 including suspicious behaviors detected, based on a scan of a ML model. The example report 400 of FIG. 4 corresponds to the first row of the scan list 300 of FIG. 3, and pertains to scan A for model A, having framework 1, version 1.2, with a source of the model being abcmodel.xyz, and a scan time of July 17, 1 PM.

As illustrated in the first row of the scan list of FIG. 3, the scan A of the example model A had 8 high level suspicious behaviors, 3 intermediate level suspicious behaviors, and zero low level suspicious behavior. FIG. 4 includes details of these suspicious behaviors. For example, the report 400 provides explanation of each of these suspicious behaviors. FIG. 4 is self-explanatory, based on the above description of various examples of suspicious behaviors.

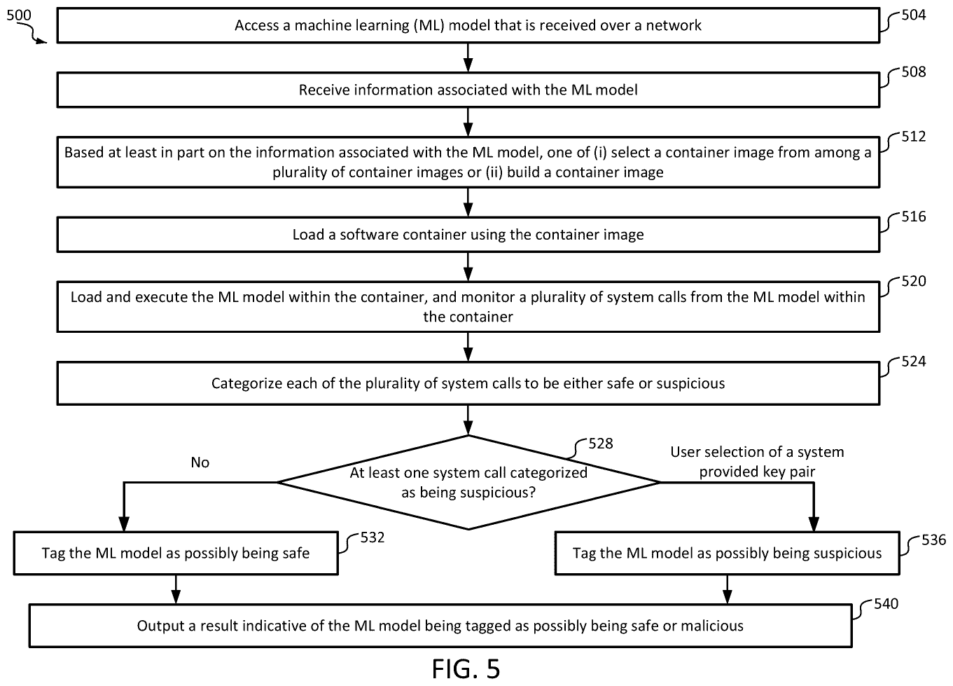

FIG. 5 illustrates a method 500 depicting a scanning process of a pretrained ML Model, to detect possibly suspicious and malicious behavior of the ML model. At 504 of the method 500, a ML model (such as the ML model 108), which is received over a network, is accessed. For example, the model scanner 120 accesses the ML model, and downloads the ML model from the model providing service 102 to the storage repository 122.

At 508, information associated with the ML model is received. For example, the testing service 133 receives such information via a user interface, e.g., as described above with respect to FIG. 2.

At 512, based at least in part on the information associated with the ML model, one of (i) a container image from among a plurality of container images is selected or (ii) a container image is built. Merely as an example and as described above, if the ML model comprises a version of PyTorch® (such as PyTorch 1.3), an image of the container is selected from among a plurality of container images or built, such that the container includes commonly used libraries for PyTorch ML models, such as Numpy® and HuggingFace® Transformers. At 516, a software container is loaded using the container image.

At 520, the ML model is loaded and executed within the container, and a plurality of system calls from the ML model within the container is monitored. For example, as described above with respect to FIG. 1, the monitoring service 130 monitors the system calls 138a, . . . , 138n. The loading and execution of the ML model may be part of a test on the ML model, where the test is defined by one of (1) selection from among a plurality of candidate tests, or (ii) a user who configured the test.

At 524, each of the plurality of system calls is categorized to be either safe or suspicious. For example, if a first system call of the plurality of system calls is within an expected behavior of the ML model, the first system call is categorized as being safe. On the other hand, if a second system call of the plurality of system calls is outside the expected behavior of the ML model, the second system call is categorized to be suspicious, as described above in further detail.

At 528, a determination is made as to whether at least one system call is categorized as being suspicious. If “No” at 528 (e.g., no system call is categorized as being suspicious), the method 500 proceeds from 528 to 532, at which the ML model is tagged as possibly being safe.

If “Yes” at 528 (e.g., one or more system calls are categorized as being suspicious), the method 500 proceeds from 528 to 536, at which the ML model is tagged as possibly being suspicious. As described above with respect to FIGS. 3 and 4, each such suspicious system call may be assigned a level of suspicion, and a behavior score may also be assigned to the ML model.

The method 500 proceeds from 532 or 536 to 540. At 540, a result in the form of a report (such as the scan list 300 of FIG. 3 or the report 400 of FIG. 4) is output, where the result is indicative of the ML model being tagged as possibly being either safe or malicious, as described above.

### Computer System Architecture

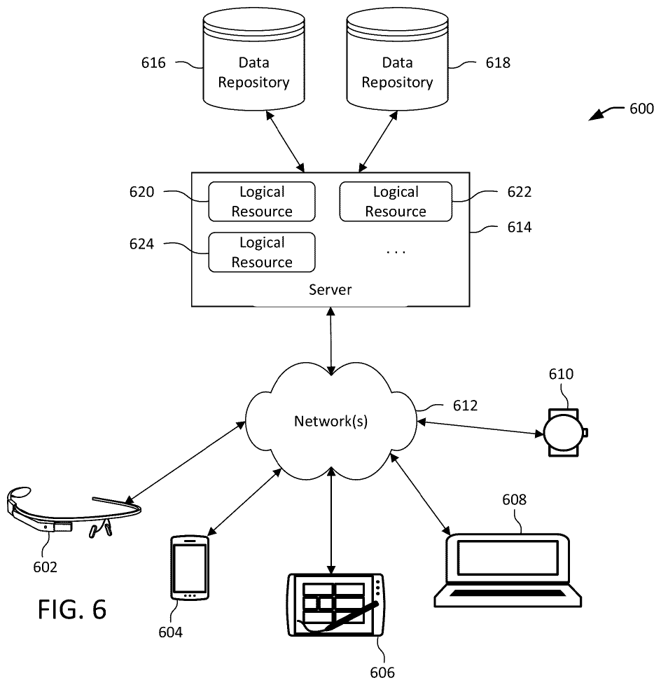

FIG. 6 depicts a simplified diagram of a distributed system 600 for implementing an embodiment. In the illustrated embodiment, distributed system 600 includes one or more client computing devices 602, 604, 606, 608, and/or 610 coupled to a server 614 via one or more communication networks 612. Clients computing devices 602, 604, 606, 608, and/or 610 may be configured to execute one or more applications.

In various aspects, server 614 may be adapted to run one or more services or software applications that enable techniques for malware detection in pretrained ML models using behavior analysis.

In certain aspects, server 614 may also provide other services or software applications that can include non-virtual and virtual environments. In some aspects, these services may be offered as web-based or cloud services, such as under a Software as a Service (SaaS) model to the users of client computing devices 602, 604, 606, 608, and/or 610. Users operating client computing devices 602, 604, 606, 608, and/or 610 may in turn utilize one or more client applications to interact with server 614 to utilize the services provided by these components.

In the configuration depicted in FIG. 6, server 614 may include one or more components 620, 622 and 624 that implement the functions performed by server 614. These components may include software components that may be executed by one or more processors, hardware components, or combinations thereof. It should be appreciated that various different system configurations are possible, which may be different from distributed system 600. The embodiment shown in FIG. 6 is thus one example of a distributed system for implementing an embodiment system and is not intended to be limiting.

Users may use client computing devices 602, 604, 606, 608, and/or 610 for techniques for malware detection in pretrained ML models using behavior analysis, in accordance with the teachings of this disclosure. A client device may provide an interface that enables a user of the client device to interact with the client device. The client device may also output information to the user via this interface. Although FIG. 6 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon Alexa®, Google Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch™, and other devices), and the like. The client devices may be capable of executing various different applications such as various Internet-related apps, communication applications (e.g., e-mail applications, short message service (SMS) applications) and may use various communication protocols.

Network(s) 612 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 612 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 614 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 614 can include one or more virtual machines running virtual operating systems, or other computing architectures involving virtualization such as one or more flexible pools of logical storage devices that can be virtualized to maintain virtual storage devices for the server. In various aspects, server 614 may be adapted to run one or more services or software applications that provide the functionality described in the foregoing disclosure.

The computing systems in server 614 may run one or more operating systems including any of those discussed above, as well as any commercially available server operating system. Server 614 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 614 may include one or more applications to analyze and consolidate data feeds and/or event updates received from users of client computing devices 602, 604, 606, 608, and/or 610. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 614 may also include one or more applications to display the data feeds and/or real-time events via one or more display devices of client computing devices 602, 604, 606, 608, and/or 610.

Distributed system 600 may also include one or more data repositories 616, 618. These data repositories may be used to store data and other information in certain aspects. For example, one or more of the data repositories 616, 618 may be used to store information for techniques for malware detection in pretrained ML models using behavior analysis. Data repositories 616, 618 may reside in a variety of locations. For example, a data repository used by server 614 may be local to server 614 or may be remote from server 614 and in communication with server 614 via a network-based or dedicated connection. Data repositories 616, 618 may be of different types. In certain aspects, a data repository used by server 614 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 616, 618 may also be used by applications to store application data. The data repositories used by applications may be of different types such as, for example, a key-value store repository, an object store repository, or a general storage repository supported by a file system.

In one embodiment, server 614 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

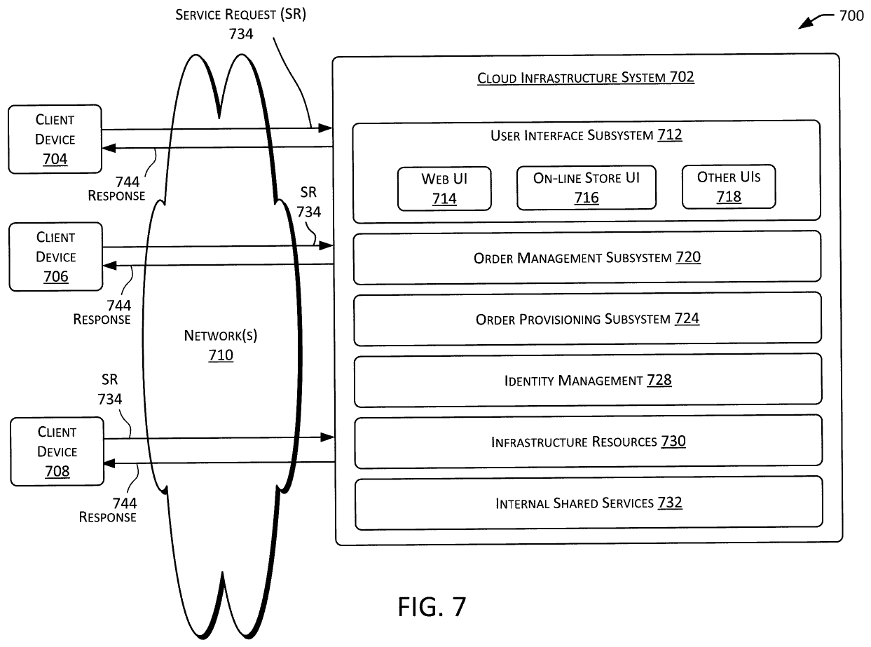

FIG. 7 is a simplified block diagram of a cloud-based system environment in which malware is detected in pretrained ML models using behavior analysis, in accordance with certain aspects. In the embodiment depicted in FIG. 7, cloud infrastructure system 702 may provide one or more cloud services that may be requested by users using one or more client computing devices 704, 706, and 708. Cloud infrastructure system 702 may comprise one or more computers and/or servers that may include those described above for server 612. The computers in cloud infrastructure system 702 may be organized as general purpose computers, specialized server computers, server farms, server clusters, or any other appropriate arrangement and/or combination.

Network(s) 710 may facilitate communication and exchange of data between clients 704, 706, and 708 and cloud infrastructure system 702. Network(s) 710 may include one or more networks. The networks may be of the same or different types. Network(s) 710 may support one or more communication protocols, including wired and/or wireless protocols, for facilitating the communications.

The embodiment depicted in FIG. 7 is only one example of a cloud infrastructure system and is not intended to be limiting. It should be appreciated that, in some other aspects, cloud infrastructure system 702 may have more or fewer components than those depicted in FIG. 7, may combine two or more components, or may have a different configuration or arrangement of components. For example, although FIG. 7 depicts three client computing devices, any number of client computing devices may be supported in alternative aspects.

The term cloud service is generally used to refer to a service that is made available to users on demand and via a communication network such as the Internet by systems (e.g., cloud infrastructure system 702) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 710 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 702 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 702 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 702. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 702. Cloud infrastructure system 702 then performs processing to provide the services requested in the tenant's subscription order. Cloud infrastructure system 702 may be configured to provide one or even multiple cloud services.

Cloud infrastructure system 702 may provide the cloud services via different deployment models. In a public cloud model, cloud infrastructure system 702 may be owned by a third party cloud services provider and the cloud services are offered to any general public tenant, where the tenant can be an individual or an enterprise. In certain other aspects, under a private cloud model, cloud infrastructure system 702 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 702 and the services provided may be shared by several organizations in a related community. Various other models such as hybrids of the above mentioned models may also be used.

Client computing devices 704, 706, and 708 may be of different types (such as devices 602, 604, 606, and 608 depicted in FIG. 6) and may be capable of operating one or more client applications. A user may use a client device to interact with cloud infrastructure system 702, such as to request a service provided by cloud infrastructure system 702.

In some aspects, the processing performed by cloud infrastructure system 702 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 702 for determining the intent of an utterance. The data used for this analysis may include structured data (e.g., data stored in a database or structured according to a structured model) and/or unstructured data (e.g., data blobs (binary large objects)).

As depicted in the embodiment in FIG. 7, cloud infrastructure system 702 may include infrastructure resources 730 that are utilized for facilitating the provision of various cloud services offered by cloud infrastructure system 702. Infrastructure resources 730 may include, for example, processing resources, storage or memory resources, networking resources, and the like.

In certain aspects, to facilitate efficient provisioning of these resources for supporting the various cloud services provided by cloud infrastructure system 702 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 702 may itself internally use services 732 that are shared by different components of cloud infrastructure system 702 and which facilitate the provisioning of services by cloud infrastructure system 702. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 702 may comprise multiple subsystems. These subsystems may be implemented in software, or hardware, or combinations thereof. As depicted in FIG. 7, the subsystems may include a user interface subsystem 712 that enables users of cloud infrastructure system 702 to interact with cloud infrastructure system 702. User interface subsystem 712 may include various different interfaces such as a web interface 714, an online store interface 716 where cloud services provided by cloud infrastructure system 702 are advertised and are purchasable by a consumer, and other interfaces 718. For example, a tenant may, using a client device, request (service request 734) one or more services provided by cloud infrastructure system 702 using one or more of interfaces 714, 716, and 718. For example, a tenant may access the online store, browse cloud services offered by cloud infrastructure system 702, and place a subscription order for one or more services offered by cloud infrastructure system 702 that the tenant wishes to subscribe to. The service request may include information identifying the tenant and one or more services that the tenant desires to subscribe to.

In certain aspects, such as the embodiment depicted in FIG. 7, cloud infrastructure system 702 may comprise an order management subsystem (OMS) 720 that is configured to process the new order. As part of this processing, OMS 720 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 720 may then invoke the order provisioning subsystem (OPS) 724 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 724 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 702 may send a response or notification 744 to the requesting tenant to indicate when the requested service is now ready for use. In some instances, information (e.g., a link) may be sent to the tenant that enables the tenant to start using and availing the benefits of the requested services.

Cloud infrastructure system 702 may provide services to multiple tenants. For each tenant, cloud infrastructure system 702 is responsible for managing information related to one or more subscription orders received from the tenant, maintaining tenant data related to the orders, and providing the requested services to the tenant or clients of the tenant. Cloud infrastructure system 702 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 702 may provide services to multiple tenants in parallel. Cloud infrastructure system 702 may store information for these tenants, including possibly proprietary information. In certain aspects, cloud infrastructure system 702 comprises an identity management subsystem (IMS) 728 that is configured to manage tenant's information and provide the separation of the managed information such that information related to one tenant is not accessible by another tenant. IMS 728 may be configured to provide various security-related services such as identity services, such as information access management, authentication and authorization services, services for managing tenant identities and roles and related capabilities, and the like.

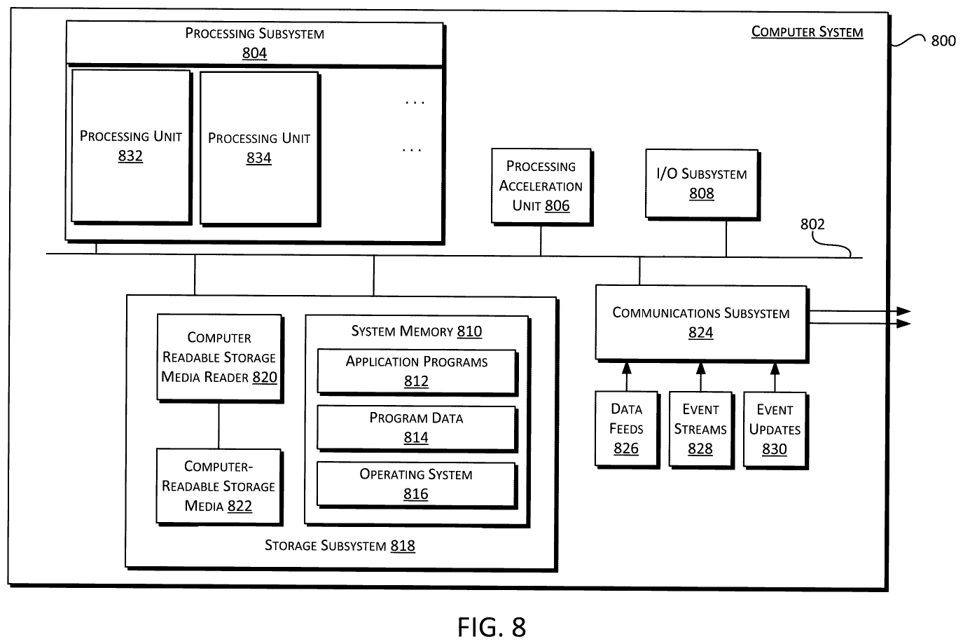

FIG. 8 illustrates an exemplary computer system 800 that may be used to implement certain aspects. As shown in FIG. 8, computer system 800 includes various subsystems including a processing subsystem 804 that communicates with a number of other subsystems via a bus subsystem 802. These other subsystems may include a processing acceleration unit 806, an I/O subsystem 808, a storage subsystem 818, and a communications subsystem 824. Storage subsystem 818 may include non-transitory computer-readable storage media including storage media 822 and a system memory 810.

Bus subsystem 802 provides a mechanism for letting the various components and subsystems of computer system 800 communicate with each other as intended. Although bus subsystem 802 is shown schematically as a single bus, alternative aspects of the bus subsystem may utilize multiple buses. Bus subsystem 802 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 804 controls the operation of computer system 800 and may comprise one or more processors, application specific integrated circuits (ASICs), or field programmable gate arrays (FPGAs). The processors may be single core or multicore processors. The processing resources of computer system 800 can be organized into one or more processing units 832, 834, etc. A processing unit may include one or more processors, one or more cores from the same or different processors, a combination of cores and processors, or other combinations of cores and processors. In some aspects, processing subsystem 804 can include one or more special purpose co-processors such as graphics processors, digital signal processors (DSPs), or the like. In some aspects, some or all of the processing units of processing subsystem 804 can be implemented using customized circuits, such as application specific integrated circuits (ASICs), or field programmable gate arrays (FPGAs).

In some aspects, the processing units in processing subsystem 804 can execute instructions stored in system memory 810 or on computer readable storage media 822. In various aspects, the processing units can execute a variety of programs or code instructions and can maintain multiple concurrently executing programs or processes. At any given time, some or all of the program code to be executed can be resident in system memory 810 and/or on computer-readable storage media 822 including potentially on one or more storage devices. Through suitable programming, processing subsystem 804 can provide various functionalities described above. In instances where computer system 800 is executing one or more virtual machines, one or more processing units may be allocated to each virtual machine.

In certain aspects, a processing acceleration unit 806 may optionally be provided for performing customized processing or for off-loading some of the processing performed by processing subsystem 804 so as to accelerate the overall processing performed by computer system 800.

I/O subsystem 808 may include devices and mechanisms for inputting information to computer system 800 and/or for outputting information from or via computer system 800. In general, use of the term input device is intended to include all possible types of devices and mechanisms for inputting information to computer system 800. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 800 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 818 provides a repository or data store for storing information and data that is used by computer system 800. Storage subsystem 818 provides a tangible non-transitory computer-readable storage medium for storing the basic programming and data constructs that provide the functionality of some aspects. Storage subsystem 818 may store software (e.g., programs, code modules, instructions) that when executed by processing subsystem 804 provides the functionality described above. The software may be executed by one or more processing units of processing subsystem 804. Storage subsystem 818 may also provide a repository for storing data used in accordance with the teachings of this disclosure.

Storage subsystem 818 may include one or more non-transitory memory devices, including volatile and non-volatile memory devices. As shown in FIG. 8, storage subsystem 818 includes a system memory 810 and a computer-readable storage media 822. System memory 810 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 800, such as during start-up, may typically be stored in the ROM. The RAM typically contains data and/or program modules that are presently being operated and executed by processing subsystem 804. In some implementations, system memory 810 may include multiple different types of memory, such as static random access memory (SRAM), dynamic random access memory (DRAM), and the like.

By way of example, and not limitation, as depicted in FIG. 8, system memory 810 may load application programs 812 that are being executed, which may include various applications such as Web browsers, mid-tier applications, relational database management systems (RDBMS), etc., program data 814, and an operating system 816. By way of example, operating system 816 may include various versions of Microsoft Windows®, Apple Macintosh®, and/or Linux operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows Phone, Android® OS, and others.

Computer-readable storage media 822 may store programming and data constructs that provide the functionality of some aspects. Computer-readable media 822 may provide storage of computer-readable instructions, data structures, program modules, and other data for computer system 800. Software (programs, code modules, instructions) that, when executed by processing subsystem 804 provides the functionality described above, may be stored in storage subsystem 818. By way of example, computer-readable storage media 822 may include non-volatile memory such as a hard disk drive, a magnetic disk drive, an optical disk drive such as a CD ROM, digital video disc (DVD), a Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 818 may also include a computer-readable storage media reader 820 that can further be connected to computer-readable storage media 822. Reader 820 may receive and be configured to read data from a memory device such as a disk, a flash drive, etc.

In certain aspects, computer system 800 may support virtualization technologies, including but not limited to virtualization of processing and memory resources. For example, computer system 800 may provide support for executing one or more virtual machines. In certain aspects, computer system 800 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 800. Accordingly, multiple operating systems may potentially be run concurrently by computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to establish a communication channel to one or more client devices via the Internet for receiving and sending information from and to the client devices.

Communication subsystem 824 may support both wired and/or wireless communication protocols. For example, in certain aspects, communications subsystem 824 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 824 can provide wired network connectivity (e.g., Ethernet) in addition to or instead of a wireless interface.

Communication subsystem 824 can receive and transmit data in various forms. For example, in some aspects, in addition to other forms, communications subsystem 824 may receive input communications in the form of structured and/or unstructured data feeds 826, event streams 828, event updates 830, and the like. For example, communications subsystem 824 may be configured to receive (or send) data feeds 826 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 824 may be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 824 may also be configured to communicate data from computer system 800 to other computer systems or networks. The data may be communicated in various different forms such as structured and/or unstructured data feeds 826, event streams 828, event updates 830, and the like to one or more databases that may be in communication with one or more streaming data source computers coupled to computer system 800.

Computer system 800 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 800 depicted in FIG. 8 is intended only as a specific example. Many other configurations having more or fewer components than the system depicted in FIG. 8 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A non-transitory computer-readable medium including instructions that when executed by one or more processors, cause a system including the one or more processors to perform operations including:
receiving a machine learning (ML) model over a network;
accessing a container image based at least in part on information associated with the ML model;
loading a software container using the container image;
loading the ML model within the container;
detecting a plurality of system calls from the ML model within the container;
categorizing one or more system calls of the plurality of system calls to be suspicious;
responsive at least in part on categorizing the one or more system calls of the plurality of system calls to be suspicious, tagging the ML model as possibly being malicious; and
outputting a result indicative of the ML model being tagged as possibly being malicious.

2. The non-transitory computer-readable medium of claim 1, wherein:
receiving information associated with the ML model comprises receiving an identification of a software framework of the ML model; and
accessing the container image comprises one of (i) selecting the container image from among a plurality of container images or (ii) building the container image, such that the selected or built container image supports the software framework of the ML model.

3. The non-transitory computer-readable medium of claim 1, wherein the operations further include:
defining a test for the ML model; and
executing the test on the ML model, wherein the test on the ML model includes loading the ML model within the container;
wherein detecting the plurality of system calls from the ML model comprises detecting the plurality of system calls from the ML model, while the test is being executed on the ML model.

4. The non-transitory computer-readable medium of claim 3, wherein the test on the ML model further includes the ML model to output an inference, based on an input.

5. The non-transitory computer-readable medium of claim 4, wherein the test on the ML model comprises one of:
issuing a load command to load the ML model, and an inference command to output the inference; or
issuing a pipeline command to load the ML model and to output the inference.

6. The non-transitory computer-readable medium of claim 3, wherein defining the test for the ML model comprises:
selecting the test from among a plurality of tests for the ML model, or receiving the test via an user interface.

7. The non-transitory computer-readable medium of claim 1, wherein the operations further include:
receiving the information associated with the ML model, wherein the information comprises one or more of (i) a software framework of the ML model, (ii) a path to a storage repository that stores the model, and (iii) a checksum of one or more files including the ML model.

8. The non-transitory computer-readable medium of claim 1, wherein categorizing one or more system calls of the plurality of system calls to be suspicious comprises:
detecting (i) a first system call to access a first file including sensitive information, and (ii) a second system call to access a second file including non-sensitive information; and
categorizing the first system call to be suspicious, without categorizing the second system call to be suspicious.

9. The non-transitory computer-readable medium of claim 8, wherein:
the sensitive information comprises one or more of (i) a plurality of passwords, (ii) one or more private keys, and (iii) operating system level information stored in the first file that is a system file; and
the non-sensitive information comprises data that is to be accessed by a legitimate ML model during its course of operation.

10. The non-transitory computer-readable medium of claim 1, wherein categorizing the one or more system calls of the plurality of system calls to be suspicious comprises:
detecting the one or more system calls to at least one of (i) bind to a network port, (ii) establish a non-Transport Layer Security (non-TLS) connection with an Internet Protocol (IP) address, (iii) attempt to establish a connection with an IP address that is excluded from a list of predefined IP addresses, and (iiiv) requests access for more than a threshold number of times to computing resources outside a current directory of the ML model; and
categorizing the one or more system calls of the plurality of system calls to be suspicious, responsive at least in part on detecting the one or more system calls to at least one of (i) bind to the network port, (ii) establish the non-TLS connection, (iii) attempt to establish a connection with an IP address that is excluded from a list of predefined IP addresses, and (iv) requests access for more than the threshold number of times.

11. The non-transitory computer-readable medium of claim 1, wherein categorizing the one or more system calls of the plurality of system calls to be suspicious comprises:
determining that (i) a first system call of the plurality of system calls is within an expected behavior of the ML model, and (ii) a second system call of the plurality of system calls is outside the expected behavior of the ML model; and
categorizing the second system call to be suspicious, without categorizing the first system call to be suspicious.

12. The non-transitory computer-readable medium of claim 1, wherein the operations further include:
prior to loading the ML model within the container, configuring a network mode of the container to disable, thereby one or both of (i) disabling inbound traffic to the container, and (ii) disabling outbound traffic from the container.

13. The non-transitory computer-readable medium of claim 1, wherein the operations further include:
prior to loading the ML model within the container, configuring the container to use a subset of a plurality of resources accessible to the container.

14. The non-transitory computer-readable medium of claim 1, wherein the ML model is a pre-trained ML model.

15. The non-transitory computer-readable medium of claim 1, wherein the operations further include:
receiving the ML over the network from a model repository storing a plurality of pre-trained ML models.

16. The non-transitory computer-readable medium of claim 1, wherein categorizing the one or more system calls of the plurality of system calls to be suspicious comprises:
categorizing a first system call of the plurality of system calls to have a first level of suspicion; and
categorizing a second system call of the plurality of system calls to have a second level of suspicion that is different from the first level of suspicion.

17. The non-transitory computer-readable medium of claim 16, wherein the operations further include:
assigning a score to the ML model, the score indicative of a degree of suspicion associated with the ML model being malicious.

18. The non-transitory computer-readable medium of claim 17, wherein the score is based at least in part on (i) a first number of system calls having the first level of suspicion, and (ii) a second number of system calls having the second level of suspicion.

19. The non-transitory computer-readable medium of claim 17, wherein tagging the ML model as possibly being malicious comprises:
tagging the ML model as possibly being malicious, responsive at least in part on the score being higher than a threshold value.

20. The non-transitory computer-readable medium of claim 17, wherein detecting the plurality of system calls comprises:
detecting the plurality of system calls using a trace utility.

21. A computer implemented method comprising:
receiving a machine learning (ML) model over a network;
accessing a container image based at least in part of information associated with the ML model;
loading a software container using the container image;
loading the ML model within the container;
detecting a plurality of system calls from the ML model within the container;
categorizing one or more system calls of the plurality of system calls to be suspicious;
responsive at least in part to categorizing the one or more system calls of the plurality of system calls to be suspicious, tagging the ML model as possibly being malicious; and
outputting a result indicative of the ML model being tagged as possibly being malicious.

22. The method of claim 21, wherein:
receiving information associated with the ML model comprises receiving an identification of a software framework of the ML model; and
accessing the container image comprises selecting the container image from among a plurality of container images, such that the selected or built container image supports the software framework of the ML model.

23. The method of claim 21, wherein categorizing the one or more system calls of the plurality of system calls to be suspicious comprises:
determining that (i) a first system call of the plurality of system calls is within an expected behavior of the ML model, and (ii) a second system call of the plurality of system calls is outside the expected behavior of the ML model; and
categorizing the second system call to be suspicious, without categorizing the first system call to be suspicious.

24. A system comprising:
one or more processors;
a storage repository configured to store a machine learning (ML) model that is received over a network; and
one or more non-transitory computer-readable media storing instructions, which, when executed by the system, cause the system to perform a set of actions including:
receiving information associated with the ML model;
accessing a container image, based at least in part of the information associated with the ML model;
loading a software container using the container image;
loading, from the storage repository, the ML model within the container;
detecting a plurality of system calls from the ML model within the container;
categorizing one or more system calls of the plurality of system calls to be suspicious;
responsive at least in part to categorizing the one or more system calls of the plurality of system calls to be suspicious, tagging the ML model as possibly being malicious; and
outputting a result indicative of the ML model being tagged as possibly being malicious.

25. The system of claim 24, wherein the ML model is a pretrained ML model received over the Internet from a cloud-based open-source repository.
